(19) United States
(12) Patent Application Publication
(10) Pub. No.: US 2026/0141631 A1
(43) Pub. Date: May 21, 2026

(54) SPATIO-TEMPORAL RECONSTRUCTION MODELING

(71) Applicant: NVIDIA CORPORATION, Santa Clara, CA (US)

(72) Inventors: Yue WANG, Los Angeles, CA (US); Jiahui HUANG, Beijing (CN); Boris IVANOVIC, Mountain View, CA (US); Yuxiao CHEN, Campbell, CA (US); Yan WANG, Santa Clara, CA (US); Boyi LI, New York, NY (US); Yurong YOU, Ithaca, NY (US); Apoorva SHARMA, Oakland, CA (US); Maximilian IGL, Küsnacht (CH); Peter KARKUS, Zurich (CH); Danfei XU, Atlanta, GA (US); Marco PAVONE, Stanford, CA (US); Jiawei YANG, Los Angeles, CA (US)

(21) Appl. No.: 19/281,406

(22) Filed: Jul. 25, 2025

Related U.S. Application Data
(60) Provisional application No. 63/721,348, filed on Nov. 15, 2024.

(51) Int. Cl. G06T 17/00; G06N 20/00; G06T 3/40; G06T 7/11; G06T 7/20; G06T 7/90; G06T 9/00

(52) U.S. Cl. CPC G06T 17/00; G06N 20/00; G06T 3/40; G06T 7/11; G06T 7/20; G06T 7/90; G06T 9/00

(57) ABSTRACT

Spatio-temporal reconstruction modeling includes receiving images of a scene, dividing each of the images into patches; generating an image token for each patch; appending one or more motion tokens to the image tokens to generate an input token vector; processing the input token vector with a machine learning (ML) model to generate an output token vector with output image and motion tokens; decoding each output image token to generate a 3D Gaussian and a motion key; decoding each output motion token to generate a velocity basis and a motion query; generating of velocity vectors based on the motion queries and the motion keys; generating a 2D image for a first timestep based on the 3D Gaussians and the velocity vectors; training the ML model based on the 2D image; generating optimized 3D Gaussians using the trained ML model; and generating a dynamic reconstructed 3D scene from the optimized 3D Gaussians.

### CROSS-REFERENCE TO RELATED APPLICATIONS

This application claims priority benefit of the United States Provisional Patent Application titled, “TECHNIQUES FOR IMPLEMENTING A SPATIO-TEMPORAL RECONSTRUCTION MODEL FOR LARGE-SCALE OUTDOOR SCENES,” filed on Nov. 15, 2024, and having Ser. No. 63/721,348. The subject matter of this related application is hereby incorporated herein by reference.

### BACKGROUND OF THE INVENTION

### Field of the Invention

Embodiments of the present disclosure relate generally to autonomous vehicle technology, dynamic three-dimensional mapping and environmental modeling, and artificial intelligence and, more specifically, to spatio-temporal reconstruction modeling.

### Description of the Related Art

Dynamic three-dimensional (3D) scene reconstruction is the task of generating an accurate 3D representation of a scene that changes over time from a set of two-dimensional (2D) images of the scene. Dynamic 3D scene reconstruction has numerous applications in a wide variety of fields, including computer graphics, animation, and autonomous vehicle mapping and navigation.

Current techniques for dynamic 3D scene reconstruction are based on neural radiance field (NERF) approaches. NERF is a technique used to reconstruct a static 3D scene (e.g. a scene without moving objects) from a set of 2D images. NERF trains a multi-layer perceptron (MLP) network to map a five-dimensional (5D) input coordinate to a volume density and view dependent emitted radiance. Given a 2D image a scene, NERF first represents that 2D scene as a continuous 5D coordinate representing a 3D spatial location and a 2D viewing direction. Next, NERF passes the 5D coordinate through an MLP network and the output of that network is an emitted color and volume density. A 2D image can then be rendered from the color and volume density using conventional volume rendering techniques, such as ray casting or shear warping. NERF then uses the trained network to render new views of the scene from different viewpoints.

Considering time as an additional input coordinate, the NERF technique is extended to dynamic 3D scene reconstruction. Dynamic-NERF (D-NERF) inputs a continuous 6D coordinate to a MLP network and learns the volume density and view dependent emitted radiance in two stages. First, D-NERF learns a spatial mapping between each point of the scene at time t and a canonical scene configuration. Next, D-NERF maps the canonical scene representation into the deformed scene at a particular time, learning the scene radiance emitted in each direction and the volume density. Then, a 2D image can be rendered from the color and volume density using conventional volume rendering techniques.

One drawback of this approach, however, is that this technique optimizes the rendered images on a per-scene basis. Per-scene optimization typically requires lengthy training times and a large number of input views to achieve a high quality 3D reconstruction.

Another drawback is that training MLPs on large, labeled datasets can take a significant amount of time and consume large amounts of computing resources. As MLPs grow in size and complexity, the computational and memory costs and latencies associated with training and deploying MLPs for various user-end applications also increase. These increasing costs and latencies can limit the overall effectiveness and usefulness of this technique.

As the foregoing illustrates, what is needed in the art are more effective techniques for dynamic 3D scene reconstruction.

### SUMMARY

According to some embodiments, a computer-implemented method for generating a 3D environment map. The method includes receiving a plurality of multi-timestep images of a scene, dividing each of the plurality of multi-timestep images into a plurality of patches, generating an image token for each patch of the plurality of patches to generate a plurality of image tokens, appending one or more motion tokens to the plurality of image tokens to generate an input token vector, processing the input token vector with a machine learning model to generate an output token vector, decoding each output image token in the output token vector to generate a 3D Gaussian and a motion key, decoding each output motion token in the output token vector to generate a velocity basis and a motion query, generating a plurality of velocity vectors based on the motion queries and the motion keys, generating an output 2D image for a first timestep based on the 3D Gaussians and the plurality of velocity vectors, training the machine learning model based on the output 2D image, generating optimized 3D Gaussians using the trained machine learning model, and generating a dynamic reconstructed 3D scene from the optimized 3D Gaussians.

Further embodiments provide, among other things, non-transitory computer-readable storage media storing instructions and systems configured to implement the method set forth above.

At least one technical advantage of the disclosed techniques relative to the prior art is that, with the disclosed techniques, accurate dynamic reconstruction of 3D scenes can be generated from a sparse number of multi-timestep images. The disclosed techniques can generate accurate dynamic reconstruction of 3D scenes from a unified representation of multi-timestep images of that scene that is consistent over time, eliminating the need for per-scene optimization which requires a large number of images and large labeled datasets to generate the dynamic reconstructed 3D scene. In addition, with the disclosed techniques accurate dynamic reconstruction of 3D scenes can be generated without having to train specialized neural models, which significantly reduces the computing resources used to generate the dynamic reconstructed 3D scene. These technical advantages represent one or more technological improvements over prior art approaches.

### BRIEF DESCRIPTION OF THE DRAWINGS

So that the manner in which the above recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 is a block diagram of a computer system configured to implement one or more aspects of the present invention;

FIG. 2 is a block diagram of a parallel processing unit included in the parallel processing subsystem of FIG. 1, according to various embodiments of the present invention;

FIG. 3 is a block diagram of a general processing cluster included in the parallel processing unit of FIG. 2, according to various embodiments of the present invention;

FIG. 4 is a block diagram of a computer-based system configured to implement one or more aspects of the various embodiments;

FIG. 5 is a more detailed description of the dynamic 3D scene reconstruction engine of FIG. 4, according to various embodiments;

FIG. 6 is a more detailed illustration of the token decoder of FIG. 5, according to various embodiments;

FIGS. 7A and 7B are a flow diagram of method steps for generating a dynamic reconstructed 3D scene, according to various embodiments; and

FIG. 8 is a flow diagram of method steps for using a dynamic reconstructed 3D scene, according to various embodiments.

### DETAILED DESCRIPTION

In the following description, numerous specific details are set forth to provide a more thorough understanding of the present invention. However, it will be apparent to one of skill in the art that the present invention may be practiced without one or more of these specific details.

Embodiments of the present disclosure provide techniques for reconstruction of a dynamic 3D scene using a set of 2D images observed at multiple timesteps. First, each 2D image is concatenated with the Plucker ray map for that 2D image then divided into patches to generate image tokens. Motion tokens and auxiliary tokens are prepended to the image tokens and input into a transformer. The transformer outputs an output token vector, with output image tokens, output motion tokens, and output auxiliary tokens. Each output auxiliary token is decoded into a scaling matrix and a bias vector or a sky color vector. Each output image token is decoded into a 3D Gaussian and a motion key. Each output motion token is decoded into a velocity basis and a motion query. Motion queries and motion keys are used to derive weights for combining the velocity bases into velocity vectors for all 3D Gaussians. Using the velocity vectors, the 3D Gaussians are aggregated into an amodal representation from all observed timesteps and translated into the target timesteps. The translated 3D Gaussians are projected and rendered onto 2D images using a splatting based technique. Then, the decoded auxiliary tokens are applied to the rendered 2D image. The transformer is trained using the rendered 2D images, depth maps of the rendered 2D images, opacity maps of the rendered 2D images, and velocity vectors for all 3D Gaussians, along with the corresponding observed 2D images, depth maps of the observed 2D images, and sky masks of the observed 2D images. In some embodiments, the training minimizes a combination of reconstruction loss, sky loss, and/or velocity regularization loss. After training, the vision transformer outputs optimized 3D Gaussians which are usable to reconstruct a dynamic 3D scene at various timesteps that closely match the originally observed 2D images.

The techniques for performing spatio-temporal reconstruction modeling have many real world applications. For example, these techniques can be used in systems where dynamic 3D scenes are reconstructed using 2D images observed at multiple timesteps, such as vehicle navigation systems, and/or the like. These techniques also have applications in virtual and augmented reality, as well as medical imaging.

The above examples are not in any way intended to be limiting. As persons skilled in the art will appreciate, as a general matter, the techniques for performing spatio-temporal reconstruction modeling that are described herein can be implemented in any application where dynamic 3D reconstruction of scenes using 2D images observed at multiple timesteps is required or useful.

### System Overview

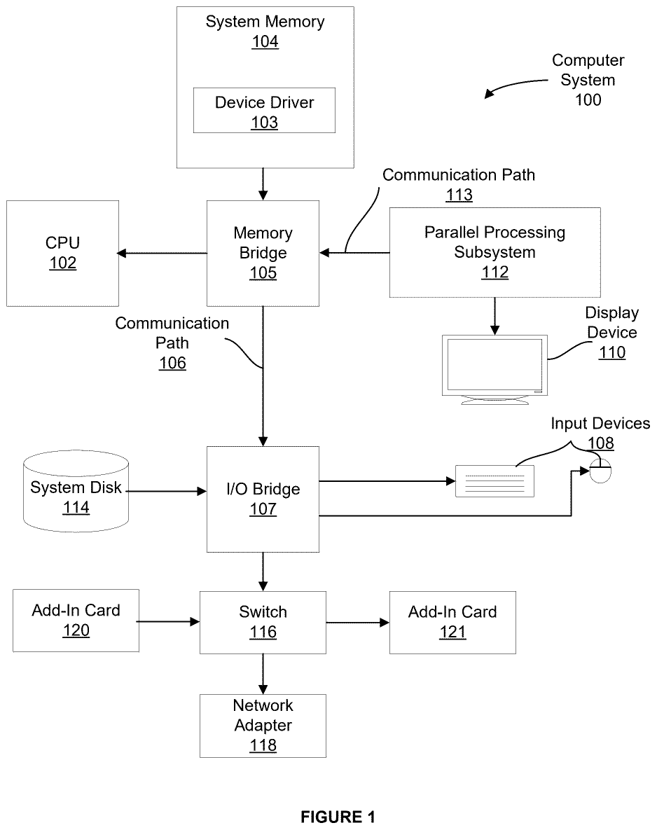

FIG. 1 is a block diagram of a computer system 100 configured to implement one or more aspects of the present invention. As shown, computer system 100 includes, without limitation, a central processing unit (CPU) 102 and a system memory 104 coupled to a parallel processing subsystem 112 via a memory bridge 105 and a communication path 113. Memory bridge 105 is further coupled to an I/O (input/output) bridge 107 via a communication path 106, and I/O bridge 107 is, in turn, coupled to a switch 116. As persons skilled in the art will appreciate, computer system 100 can be any type of technically feasible computer system, including, without limitation, a server machine, a server platform, a desktop machine, laptop machine, or a hand-held/mobile device. Persons skilled in the art also will appreciate that computer system 100 or systems similar to computer system 100 can be incorporated into a vehicle or machine to facilitate driving, steering, or otherwise controlling that vehicle or machine, as the case may be.

In operation, I/O bridge 107 is configured to receive user input information from input devices 108, such as a keyboard or a mouse, and forward the input information to CPU 102 for processing via communication path 106 and memory bridge 105. Switch 116 is configured to provide connections between I/O bridge 107 and other components of the computer system 100, such as a network adapter 118 and various add-in cards 120 and 121.

As also shown, I/O bridge 107 is coupled to a system disk 114 that may be configured to store content and applications and data for use by CPU 102 and parallel processing subsystem 112. As a general matter, system disk 114 provides non-volatile storage for applications and data and may include fixed or removable hard disk drives, flash memory devices, and CD-ROM (compact disc read-only-memory), DVD-ROM (digital versatile disc-ROM), Blu-ray, HD-DVD (high definition DVD), or other magnetic, optical, or solid state storage devices. Finally, although not explicitly shown, other components, such as universal serial bus or other port connections, compact disc drives, digital versatile disc drives, film recording devices, and the like, may be connected to I/O bridge 107 as well.

In various embodiments, memory bridge 105 may be a Northbridge chip, and I/O bridge 107 may be a Southbrige chip. In addition, communication paths 106 and 113, as well as other communication paths within computer system 100, may be implemented using any technically suitable protocols, including, without limitation, AGP (Accelerated Graphics Port), HyperTransport, or any other bus or point-to-point communication protocol known in the art.

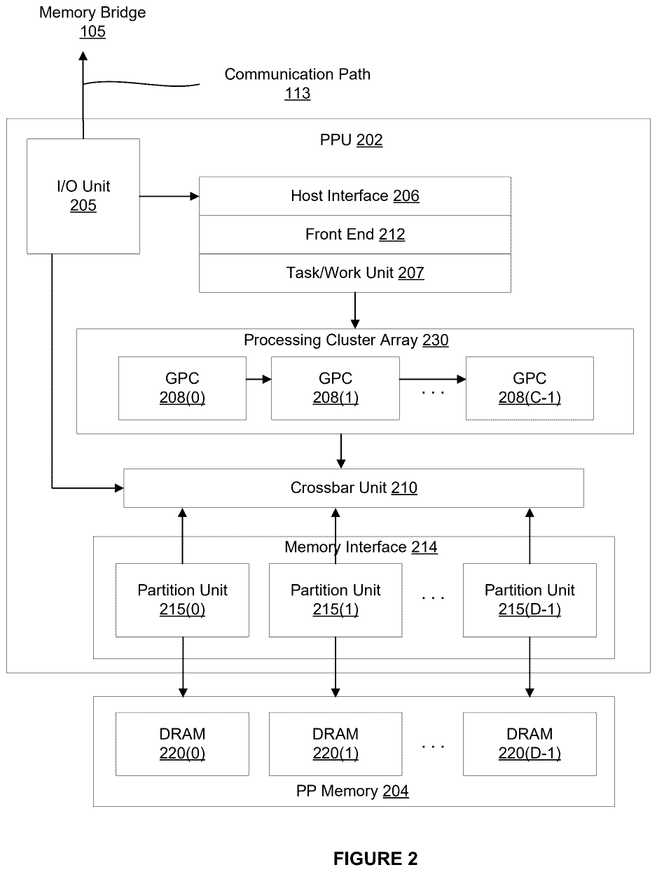

In some embodiments, parallel processing subsystem 112 comprises a graphics subsystem that delivers pixels to a display device 110 that may be any conventional cathode ray tube, liquid crystal display, light-emitting diode display, or the like. In such embodiments, the parallel processing subsystem 112 incorporates circuitry optimized for graphics and video processing, including, for example, video output circuitry. As described in greater detail below in FIG. 2, such circuitry may be incorporated across one or more parallel processing units (PPUs) included within parallel processing subsystem 112. In other embodiments, the parallel processing subsystem 112 incorporates circuitry optimized for general purpose and/or compute processing. Again, such circuitry may be incorporated across one or more PPUs included within parallel processing subsystem 112 that are configured to perform such general purpose and/or compute operations. In yet other embodiments, the one or more PPUs included within parallel processing subsystem 112 may be configured to perform graphics processing, general purpose processing, and compute processing operations. System memory 104 includes at least one device driver 103 configured to manage the processing operations of the one or more PPUs within parallel processing subsystem 112.

In various embodiments, parallel processing subsystem 112 may be integrated with one or more other the other elements of FIG. 1 to form a single system. For example, parallel processing subsystem 112 may be integrated with CPU 102 and other connection circuitry on a single chip to form a system on chip (SoC).

It will be appreciated that the system shown herein is illustrative and that variations and modifications are possible. The connection topology, including the number and arrangement of bridges, the number of CPUs 102, and the number of parallel processing subsystems 112, may be modified as desired. For example, in some embodiments, system memory 104 could be connected to CPU 102 directly rather than through memory bridge 105, and other devices would communicate with system memory 104 via memory bridge 105 and CPU 102. In other alternative topologies, parallel processing subsystem 112 may be connected to I/O bridge 107 or directly to CPU 102, rather than to memory bridge 105. In still other embodiments, I/O bridge 107 and memory bridge 105 may be integrated into a single chip instead of existing as one or more discrete devices. Lastly, in certain embodiments, one or more components shown in FIG. 1 may not be present. For example, switch 116 could be eliminated, and network adapter 118 and add-in cards 120, 121 would connect directly to I/O bridge 107.

FIG. 2 is a block diagram of a parallel processing unit (PPU) 202 included in the parallel processing subsystem 112 of FIG. 1, according to various embodiments of the present invention. Although FIG. 2 depicts one PPU 202, as indicated above, parallel processing subsystem 112 may include any number of PPUs 202. As shown, PPU 202 is coupled to a local parallel processing (PP) memory 204. PPU 202 and PP memory 204 may be implemented using one or more integrated circuit devices, such as programmable processors, application specific integrated circuits (ASICs), or memory devices, or in any other technically feasible fashion.

In some embodiments, PPU 202 comprises a graphics processing unit (GPU) that may be configured to implement a graphics rendering pipeline to perform various operations related to generating pixel data based on graphics data supplied by CPU 102 and/or system memory 104. When processing graphics data, PP memory 204 can be used as graphics memory that stores one or more conventional frame buffers and, if needed, one or more other render targets as well. Among other things, PP memory 204 may be used to store and update pixel data and deliver final pixel data or display frames to display device 110 for display. In some embodiments, PPU 202 also may be configured for general-purpose processing and compute operations.

In operation, CPU 102 is the master processor of computer system 100, controlling and coordinating operations of other system components. In particular, CPU 102 issues commands that control the operation of PPU 202. In some embodiments, CPU 102 writes a stream of commands for PPU 202 to a data structure (not explicitly shown in either FIG. 1 or FIG. 2) that may be located in system memory 104, PP memory 204, or another storage location accessible to both CPU 102 and PPU 202. A pointer to the data structure is written to a pushbuffer to initiate processing of the stream of commands in the data structure. The PPU 202 reads command streams from the pushbuffer and then executes commands asynchronously relative to the operation of CPU 102. In embodiments where multiple pushbuffers are generated, execution priorities may be specified for each pushbuffer by an application program via device driver 103 to control scheduling of the different pushbuffers.

As also shown, PPU 202 includes an I/O (input/output) unit 205 that communicates with the rest of computer system 100 via the communication path 113 and memory bridge 105. I/O unit 205 generates packets (or other signals) for transmission on communication path 113 and also receives all incoming packets (or other signals) from communication path 113, directing the incoming packets to appropriate components of PPU 202. For example, commands related to processing tasks may be directed to a host interface 206, while commands related to memory operations (e.g., reading from or writing to PP memory 204) may be directed to a crossbar unit 210. Host interface 206 reads each pushbuffer and transmits the command stream stored in the pushbuffer to a front end 212.

As mentioned above in conjunction with FIG. 1, the connection of PPU 202 to the rest of computer system 100 may be varied. In some embodiments, parallel processing subsystem 112, which includes at least one PPU 202, is implemented as an add-in card that can be inserted into an expansion slot of computer system 100. In other embodiments, PPU 202 can be integrated on a single chip with a bus bridge, such as memory bridge 105 or I/O bridge 107. Again, in still other embodiments, some or all of the elements of PPU 202 may be included along with CPU 102 in a single integrated circuit or system of chip (SoC).

In operation, front end 212 transmits processing tasks received from host interface 206 to a work distribution unit (not shown) within task/work unit 207. The work distribution unit receives pointers to processing tasks that are encoded as task metadata (TMD) and stored in memory. The pointers to TMDs are included in a command stream that is stored as a pushbuffer and received by the front end 212 from the host interface 206. Processing tasks that may be encoded as TMDs include indices associated with the data to be processed as well as state parameters and commands that define how the data is to be processed. For example, the state parameters and commands could define the program to be executed on the data. The task/work unit 207 receives tasks from the front end 212 and ensures that GPCs 208 are configured to a valid state before the processing task specified by each one of the TMDs is initiated. A priority may be specified for each TMD that is used to schedule the execution of the processing task. Processing tasks also may be received from the processing cluster array 230. Optionally, the TMD may include a parameter that controls whether the TMD is added to the head or the tail of a list of processing tasks (or to a list of pointers to the processing tasks), thereby providing another level of control over execution priority.

PPU 202 advantageously implements a highly parallel processing architecture based on a processing cluster array 230 that includes a set of C general processing clusters (GPCs) 208, where C 1. Each GPC 208 is capable of executing a large number (e.g., hundreds or thousands) of threads concurrently, where each thread is an instance of a program. In various applications, different GPCs 208 may be allocated for processing different types of programs or for performing different types of computations. The allocation of GPCs 208 may vary depending on the workload arising for each type of program or computation.

Memory interface 214 includes a set of D of partition units 215, where D□1. Each partition unit 215 is coupled to one or more dynamic random access memories (DRAMs) 220 residing within PPM memory 204. In one embodiment, the number of partition units 215 equals the number of DRAMs 220, and each partition unit 215 is coupled to a different DRAM 220. In other embodiments, the number of partition units 215 may be different than the number of DRAMs 220. Persons of ordinary skill in the art will appreciate that a DRAM 220 may be replaced with any other technically suitable storage device. In operation, various render targets, such as texture maps and frame buffers, may be stored across DRAMs 220, allowing partition units 215 to write portions of each render target in parallel to efficiently use the available bandwidth of PP memory 204.

A given GPCs 208 may process data to be written to any of the DRAMs 220 within PP memory 204. Crossbar unit 210 is configured to route the output of each GPC 208 to the input of any partition unit 215 or to any other GPC 208 for further processing. GPCs 208 communicate with memory interface 214 via crossbar unit 210 to read from or write to various DRAMs 220. In one embodiment, crossbar unit 210 has a connection to I/O unit 205, in addition to a connection to PP memory 204 via memory interface 214, thereby enabling the processing cores within the different GPCs 208 to communicate with system memory 104 or other memory not local to PPU 202. In the embodiment of FIG. 2, crossbar unit 210 is directly connected with I/O unit 205. In various embodiments, crossbar unit 210 may use virtual channels to separate traffic streams between the GPCs 208 and partition units 215.

Again, GPCs 208 can be programmed to execute processing tasks relating to a wide variety of applications, including, without limitation, linear and nonlinear data transforms, filtering of video and/or audio data, modeling operations (e.g., applying laws of physics to determine position, velocity and other attributes of objects), image rendering operations (e.g., tessellation shader, vertex shader, geometry shader, and/or pixel/fragment shader programs), general compute operations, etc. In operation, PPU 202 is configured to transfer data from system memory 104 and/or PP memory 204 to one or more on-chip memory units, process the data, and write result data back to system memory 104 and/or PP memory 204. The result data may then be accessed by other system components, including CPU 102, another PPU 202 within parallel processing subsystem 112, or another parallel processing subsystem 112 within computer system 100.

As noted above, any number of PPUs 202 may be included in a parallel processing subsystem 112. For example, multiple PPUs 202 may be provided on a single add-in card, or multiple add-in cards may be connected to communication path 113, or one or more of PPUs 202 may be integrated into a bridge chip. PPUs 202 in a multi-PPU system may be identical to or different from one another. For example, different PPUs 202 might have different numbers of processing cores and/or different amounts of PP memory 204. In implementations where multiple PPUs 202 are present, those PPUs may be operated in parallel to process data at a higher throughput than is possible with a single PPU 202. Systems incorporating one or more PPUs 202 may be implemented in a variety of configurations and form factors, including, without limitation, desktops, laptops, handheld personal computers or other handheld devices, servers, workstations, game consoles, embedded systems, and the like.

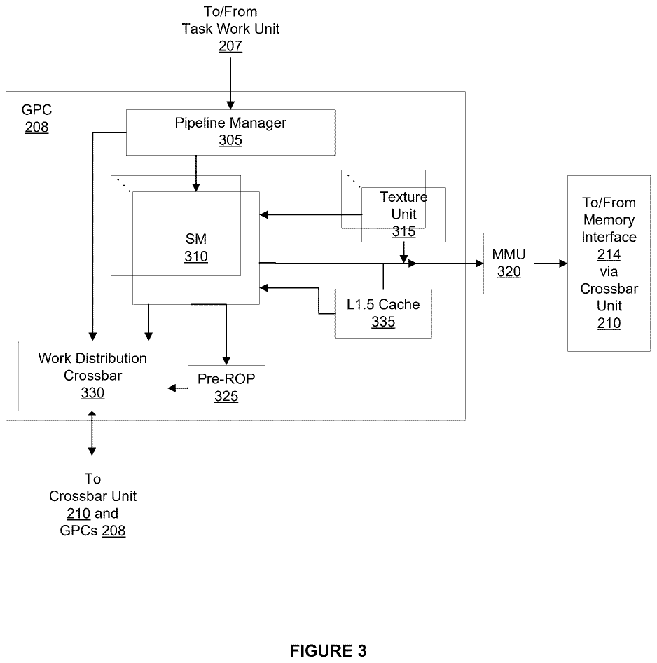

FIG. 3 is a block diagram of a GPC 208 included in PPU 202 of FIG. 2, according to various embodiments of the present invention. In operation, GPC 208 may be configured to execute a large number of threads in parallel to perform graphics, general processing and/or compute operations. As used herein, a “thread” refers to an instance of a particular program executing on a particular set of input data. In some embodiments, single-instruction, multiple-data (SIMD) instruction issue techniques are used to support parallel execution of a large number of threads without providing multiple independent instruction units. In other embodiments, single-instruction, multiple-thread (SIMT) techniques are used to support parallel execution of a large number of generally synchronized threads, using a common instruction unit configured to issue instructions to a set of processing engines within GPC 208. Unlike a SIMD execution regime, where all processing engines typically execute identical instructions, SIMT execution allows different threads to more readily follow divergent execution paths through a given program. Persons of ordinary skill in the art will understand that a SIMD processing regime represents a functional subset of a SIMT processing regime.

Operation of GPC 208 is controlled via a pipeline manager 305 that distributes processing tasks received from a work distribution unit (not shown) within task/work unit 207 to one or more streaming multiprocessors (SMs) 310. Pipeline manager 305 may also be configured to control a work distribution crossbar 330 by specifying destinations for processed data output by SMs 310.

In one embodiment, GPC 208 includes a set of M of SMs 310, where M≥1. Also, each SM 310 includes a set of functional execution units (not shown), such as execution units and load-store units. Processing operations specific to any of the functional execution units may be pipelined, which enables a new instruction to be issued for execution before a previous instruction has completed execution. Any combination of functional execution units within a given SM 310 may be provided. In various embodiments, the functional execution units may be configured to support a variety of different operations including integer and floating point arithmetic (e.g., addition and multiplication), comparison operations, Boolean operations (AND, OR, XOR), bit-shifting, and computation of various algebraic functions (e.g., planar interpolation and trigonometric, exponential, and logarithmic functions, etc.). Advantageously, the same functional execution unit can be configured to perform different operations.

In operation, each SM 310 is configured to process one or more thread groups. As used herein, a “thread group” or “warp” refers to a group of threads concurrently executing the same program on different input data, with one thread of the group being assigned to a different execution unit within an SM 310. A thread group may include fewer threads than the number of execution units within the SM 310, in which case some of the execution may be idle during cycles when that thread group is being processed. A thread group may also include more threads than the number of execution units within the SM 310, in which case processing may occur over consecutive clock cycles. Since each SM 310 can support up to G thread groups concurrently, it follows that up to G*M thread groups can be executing in GPC 208 at any given time.

Additionally, a plurality of related thread groups may be active (in different phases of execution) at the same time within an SM 310. This collection of thread groups is referred to herein as a “cooperative thread array” (“CTA”) or “thread array.” The size of a particular CTA is equal to m*k, where k is the number of concurrently executing threads in a thread group, which is typically an integer multiple of the number of execution units within the SM 310, and m is the number of thread groups simultaneously active within the SM 310.

Although not shown in FIG. 3, each SM 310 contains a level one (L1) cache or uses space in a corresponding L1 cache outside of the SM 310 to support, among other things, load and store operations performed by the execution units. Each SM 310 also has access to level two (L2) caches (not shown) that are shared among all GPCs 208 in PPU 202. The L2 caches may be used to transfer data between threads. Finally, SMs 310 also have access to off-chip “global” memory, which may include PP memory 204 and/or system memory 104. It is to be understood that any memory external to PPU 202 may be used as global memory. Additionally, as shown in FIG. 3, a level one-point-five (L1.5) cache 335 may be included within GPC 208 and configured to receive and hold data requested from memory via memory interface 214 by SM 310. Such data may include, without limitation, instructions, uniform data, and constant data. In embodiments having multiple SMs 310 within GPC 208, the SMs 310 may beneficially share common instructions and data cached in L1.5 cache 335.

Each GPC 208 may have an associated memory management unit (MMU) 320 that is configured to map virtual addresses into physical addresses. In various embodiments, MMU 320 may reside either within GPC 208 or within the memory interface 214. The MMU 320 includes a set of page table entries (PTEs) used to map a virtual address to a physical address of a tile or memory page and optionally a cache line index. The MMU 320 may include address translation lookaside buffers (TLB) or caches that may reside within SMs 310, within one or more L1 caches, or within GPC 208.

In graphics and compute applications, GPC 208 may be configured such that each SM 310 is coupled to a texture unit 315 for performing texture mapping operations, such as determining texture sample positions, reading texture data, and filtering texture data.

In operation, each SM 310 transmits a processed task to work distribution crossbar 330 in order to provide the processed task to another GPC 208 for further processing or to store the processed task in an L2 cache (not shown), parallel processing memory 204, or system memory 104 via crossbar unit 210. In addition, a pre-raster operations (preROP) unit 325 is configured to receive data from SM 310, direct data to one or more raster operations (ROP) units within partition units 215, perform optimizations for color blending, organize pixel color data, and perform address translations.

It will be appreciated that the core architecture described herein is illustrative and that variations and modifications are possible. Among other things, any number of processing units, such as SMs 310, texture units 315, or preROP units 325, may be included within GPC 208. Further, as described above in conjunction with FIG. 2, PPU 202 may include any number of GPCs 208 that are configured to be functionally similar to one another so that execution behavior does not depend on which GPC 208 receives a particular processing task. Further, each GPC 208 operates independently of the other GPCs 208 in PPU 202 to execute tasks for one or more application programs. In view of the foregoing, persons of ordinary skill in the art will appreciate that the architecture described in FIGS. 1-3 in no way limits the scope of the present invention.

### Dynamic Reconstructed 3D Scene Generation and Use

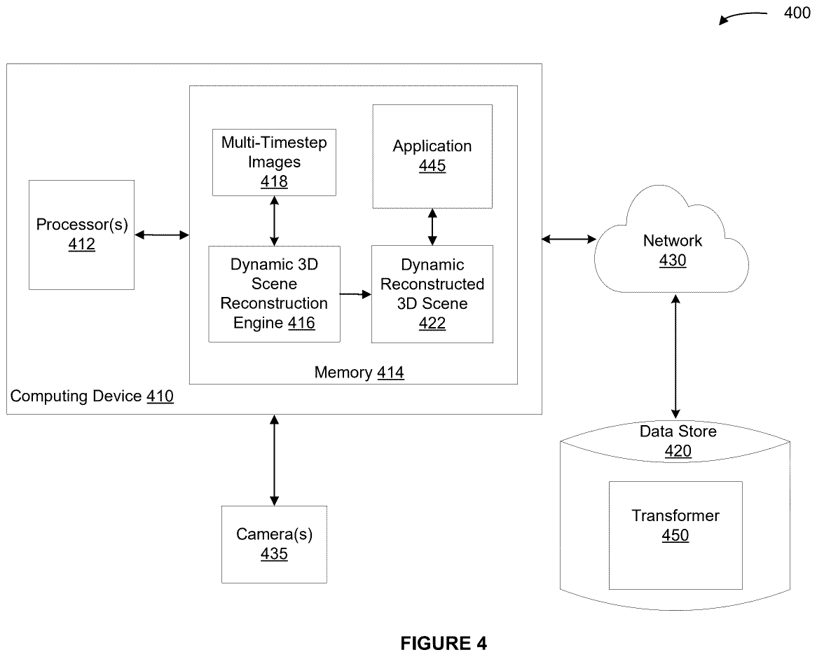

FIG. 4 illustrates a block diagram of a computer-based system 400 configured to implement one or more aspects of the various embodiments. As shown, computer-based system 400 includes, without limitation, a computing device 410, a data store 420, a network 430, and camera(s) 435. Computing device 410 includes, without limitation, processor(s) 412 and a memory 414. Memory 414 includes, without limitation, a dynamic 3D scene reconstruction engine 416, multi-timestep images 418, dynamic reconstructed 3D scene 422, and application 445. Data store 420 stores, without limitation, transformer 450. Computing device 410 can include similar components, features, and/or functionality as the exemplary computer system 100, described above in conjunction with FIG. 1-3. Computing device 410 can be any technically feasible type of computer system, including, without limitation, a server machine or a server platform.

Computing device 410 shown herein is for illustrative purposes only, and variations and modifications are possible without departing from the scope of the present disclosure. For example, the number and types of processor(s) 412, the number of GPUs and/or other processing unit types, the number and types of system memory 414, and/or the number of applications included in the memory 414 can be modified as desired. Further, the connection topology between the various units within computing device 410 can be modified as desired. In some embodiments, any combination of the processor(s) 412 and the memory 414, and/or GPU(s) can be included in and/or replaced with any type of virtual computing system, distributed computing system, and/or cloud computing environment, such as a public, private, or a hybrid cloud system.

Processor(s) 412 receive user input from input devices, such as a keyboard or a mouse. Processor(s) 412 can be any technically feasible form of processing device configured to process data and execute program code. For example, any of processor(s) 412 could be a central processing unit (CPU), a graphics processing unit (GPU), an application-specific integrated circuit (ASIC), a field-programmable gate array (FPGA), and so forth. In various embodiments any of the operations and/or functions described herein can be performed by processor(s) 412, or any combination of these different processors, such as a CPU working in cooperation with one or more GPUs. In various embodiments, the processor(s) 412 can issue commands that control the operation of one or more GPUs (not shown) and/or other parallel processing circuitry (e.g., parallel processing units, deep learning accelerators, etc.) that incorporates circuitry optimized for graphics and video processing, including, for example, video output circuitry. The GPU(s) can deliver pixels to a display device that can be any conventional cathode ray tube, liquid crystal display, light-emitting diode display, and/or the like.

Memory 414 of computing device 410 stores content, such as software applications and data, for use by processor(s) 412. Memory 414 can be any type of memory capable of storing data and software applications, such as a random-access memory (RAM), a read-only memory (ROM), an erasable programmable read-only memory (EPROM or Flash ROM), or any suitable combination of the foregoing. In some embodiments, a storage (not shown) can supplement or replace memory 414. The storage can include any number and type of external memories that are accessible to processor(s) 412. For example, and without limitation, the storage can include a Secure Digital Card, an external Flash memory, a portable compact disc read-only memory (CD-ROM), an optical storage device, a magnetic storage device, and/or any suitable combination of the foregoing.

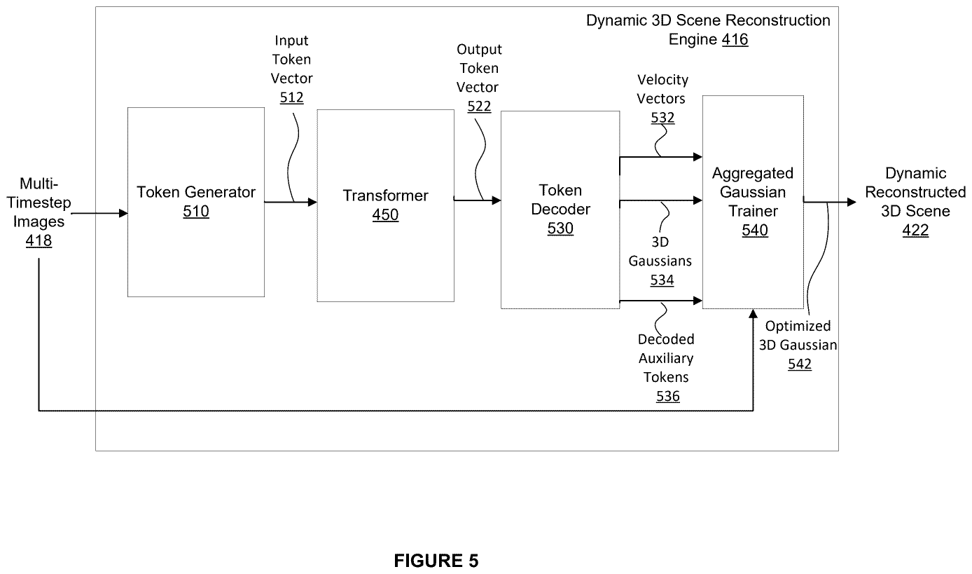

Dynamic 3D scene reconstruction engine 416 stored within memory 414 is configured to generate dynamic reconstructed 3D scene 422 using multi-timestep images 418. First, each multi-timestep image 418 is divided into patches to generate image tokens. Next, motion tokens and auxiliary tokens are prepended to the image tokens to generate an input token vector. The input token vector is input into a vision transformer and the vision transformer outputs an output token vector. The output token vector is decoded into velocity vectors and 3D Gaussians. The velocity vectors and the 3D Gaussians are aggregated into an amodal representation from all observed timesteps and transformed into target timesteps. The transformed 3D Gaussians are projected and rendered onto 2D images using a splatting based technique. The transformer 450 is trained using the rendered 2D images and, after training, outputs optimized 3D Gaussians which are usable to reconstruct dynamic reconstructed 3D scene 422. Dynamic reconstructed 3D scene 422 can then be used in any suitable application, such as application 445 executing on computing device 410. The operations performed by dynamic 3D scene reconstruction engine 416 to generate dynamic reconstructed 3D scene 422 are described in greater detail below in conjunction with FIGS. 5-7.

Multi-timestep images 418 are images obtained from the same scene at different times in a given time interval. Multi-timestep images 418 can be obtained by any type of technically feasible camera or video capture device such as camera(s) 435. For example, and without limitation, multi-timestep images 418 can be obtained by a monocular camera such as a smartphone camera or a camera located in a vehicle. In various embodiments, multi-timestep images 418 can include images of the same scene at different times in a given time interval from one or more viewpoints. Multi-timestep images 418 can be loaded by dynamic 3D scene reconstruction engine 416 from camera(s) 435.

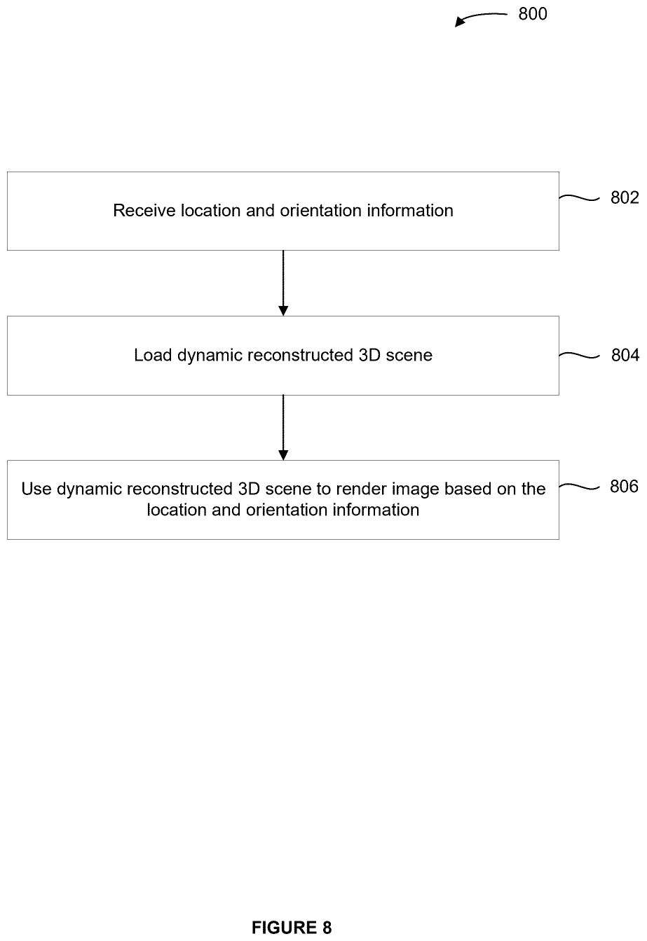

Application 445 accesses dynamic reconstructed 3D scene 422. Application 445 can be, without limitation, any type of navigation system, map, route and direction assistant, visualization assistant, and/or like in an autonomous or manned vehicle, a hand-held device, and/or a stationary device. For example, application 445 can load dynamic reconstructed 3D scene 422 and then use vehicle location and position information and dynamic reconstructed 3D scene 422 to render an image of the current location for a specific timestep. In various embodiments, application 445 shows previews of a planned route, renders a view from specific coordinates and timestep, or annotates an image to displays landmarks or other points of interest. The operations performed by application 445 are described in greater detail below in conjunction with FIG. 8.

Data store 420 provides non-volatile storage for applications and data in computing device 410. For example, and without limitation, training data, trained (or deployed) machine learning models and/or application data, transformer 450, multi-timestep images 418, and dynamic reconstructed 3D scene 422 can be stored in the data store 420 for use by application 445. In some embodiments, data store 420 can include fixed or removable hard disk drives, flash memory devices, and CD-ROM (compact disc read-only-memory), DVD-ROM (digital versatile disc-ROM), Blu-ray, HD-DVD (high definition DVD), or other magnetic, optical, or solid state storage devices. Data store 420 can be a network attached storage (NAS) and/or a storage area-network (SAN). Although shown as coupled to computing device 410 via network 430, in various embodiments, computing device 410 can include data store 420.

Camera(s) 435 includes any technically feasible type of camera or video capture device. For example, and without limitation, camera(s) 435 can be a monocular camera such as a smartphone camera or a camera located in a vehicle. In various embodiments, camera(s) 435 sends multi-timestep images 418 captured at different timesteps to computing device 410 to be loaded by dynamic 3D scene reconstruction engine 416.

Network 430 includes any technically feasible type of communications network that allows data to be exchanged between computing device 410, data store 420 and external entities or devices, such as a web server or another networked computing device. For example, network 430 can include a wide area network (WAN), a local area network (LAN), a cellular network, a wireless (WiFi) network, and/or the Internet, among others.

FIG. 5 is a more detailed illustration of dynamic 3D scene reconstruction engine 416 of FIG. 4, according to various embodiments. As shown, dynamic 3D scene reconstruction engine 416 includes, without limitation, token generator 510, input token vector 512, transformer 450, output token vector 522, token decoder 530, velocity vectors 532, 3D Gaussians 534, decoded auxiliary tokens 536, aggregated Gaussian trainer 540, and optimized 3D Gaussians 542. In operation, dynamic 3D scene reconstruction engine 416 receives multi-timestep images 418 and generates dynamic reconstructed 3D scene 422. In various embodiments, multi-timestep images 418 can include images of the same scene at different times in a given time interval from one or more viewpoints.

Token generator 510 uses multi-timestep images 418 to generate input token vector 512. First, each multi-timestep image 418 is concatenated channel-wise with the Plucker ray map corresponding to multi-timestep image 418. The Plucker ray map encodes the ray origins and directions corresponding to each pixel in a multi-timestep image 418 and is computed using the intrinsic and extrinsic camera parameters corresponding to the multi-timestep image 418. The concatenated multi-timestep image 418 and Plucker ray map are then divided into non-overlapping 2D patches. Each 2D patch is flattened into a 1D vector and the 1D vector is then embedded through a linear patch embedding layer to obtain an image token for the 2D patch. The image tokens for each multi-timestep image 418 are then concatenated. Next, motion tokens and auxiliary tokens are prepended to the image tokens to generate input token vector 512. Motion tokens and auxiliary tokens are learnable tokens initialized randomly. Motion tokens are used to capture common motion patterns in multi-timestep images 418. Auxiliary tokens include a sky token, to capture sky information from multi-timestep images 418, and an affine token, to capture exposure variations between camera(s) 435. Input token vector 512 is then passed to transformer 450.

Transformer 450 can be any type of technically feasible transformer-based machine learning model. For example, in various embodiments, transformer 450 can be a vision transformer with any suitable architecture. More generally, the input dataset to transformer 450 can include any technically feasible data that can be processed by a transformer-based model for computer vision. Upon receiving input token vector 512, transformer 450 passes input token vector 512 through multiple transformer blocks. Each transformer block of transformer 450 can include multiple layers, including an attention layer, a multilayer perceptron (MLP) layer, and/or the like. Each transformer block has varying numbers of internal parameters including, without limitation, numbers of attention heads, key-value projection dimensions, numbers of neurons, types of activation functions, and/or the like. In various embodiments, each layer in transformer block of transformer 450 includes a layer norm layer, a linear layer, a convolutional layer, a pooling layer, a softmax layer, and/or any other type of viable artificial neural network layer. After passing input token vector 512 through the transformer blocks of transformer 450, transformer 450 generates output token vector 522.

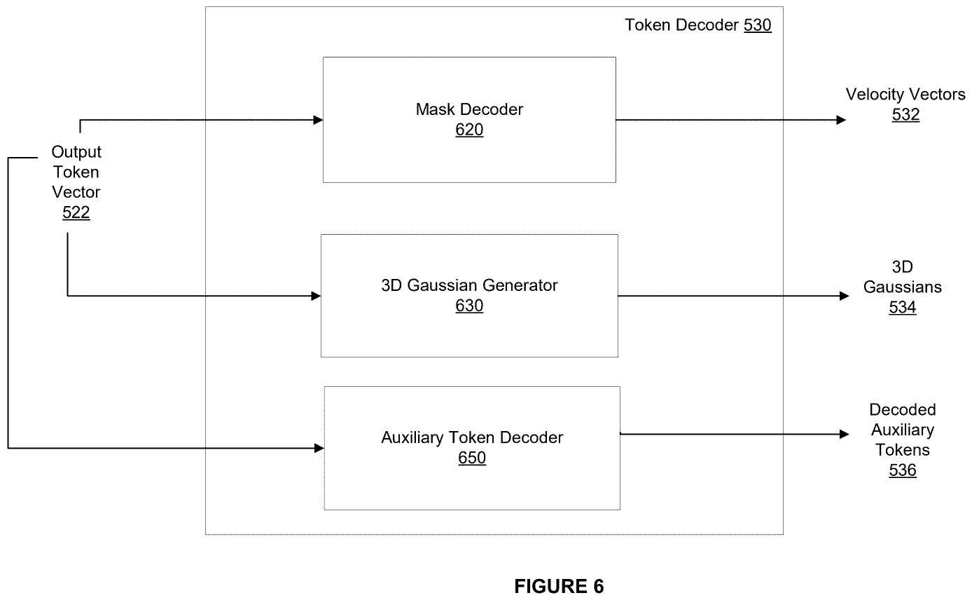

Token decoder 530 receives output token vector 522 from transformer 450. Output token vector 522 includes output image tokens, output motion tokens, and output auxiliary tokens. Output auxiliary tokens can include output affine tokens, output sky color tokens, and/or the like. Token decoder 530 decodes each output auxiliary token of output token vector 522 into a scaling matrix and a bias vector or a sky color vector. Token decoder 530 decodes each output image token of output token vector 522 into a 3D Gaussian and a motion key. Token decoder 530 decodes each output motion token of output token vector 522 into a velocity basis and a motion query. The operations of token decoder 530 are described in further detail below in conjunction with FIG. 6.

FIG. 6 is a more detailed illustration of token decoder 530 of FIG. 5, according to various embodiments. As shown, token decoder 530 includes, without limitation, mask decoder 620, 3D Gaussian generator 630, and auxiliary token decoder 650. As noted above, token decoder 530 receives output token vector 522 and generates velocity vectors 532, 3D Gaussians 534, and decoded auxiliary tokens 536.

Mask decoder 620 receives output motion tokens and output image tokens of output token vector 522. First, mask decoder 620 passes each motion token of output token vector 522 through a set of multilayer perceptron layers to generate a velocity basis, vb=(vb⁻, vb⁺), and a motion query vector q. Then, mask decoder 620 passes each output image token of output token vector 522 through several deconvolutional layers to generate a motion key vector k. Next, mask decoder 620 derives weights for combining the velocity bases by computing the similarity between the motion queries and motion keys according to equation (1):

$${w}_{m}^{( i , j )} = \frac{exp ( \frac{{q}_{m} \cdot {k}_{i , j}}{τ} )}{{Σ}_{{m}^{′}}^{M} exp ( \frac{{q}_{{m}^{′}} \cdot {k}_{i , j}}{τ} )} \qquad ( 1 )$$

where w^{i,j} is the weigh at each spatial location (i, j), τ is a hyperparameter, q is a motion query vector, k_{i,j} is a motion key vector corresponding to a spatial location (i, j). The weights given by equation (1) and the velocity bases are then combined to generate velocity vectors 532 according to equation (2):

$${ν}^{( i , j )} = {Σ}_{m = 1}^{M} {w}_{m}^{( i , j )} ν {b}_{m} \qquad ( 2 )$$

where

$${Σ}_{m = 1}^{M} {w}_{m}^{( i , j )} = 1 and 0 \leq {w}_{m}^{( i , j )} \leq 1 .$$

Mask decoder 620 then passes velocity vectors 532 to aggregated Gaussian trainer 540.

3D Gaussian generator 630 receives output image tokens of output token vector 522 and generates 3D Gaussians 534. 3D Gaussian generator 630 passes each output image token of output token vector 522 through a linear layer to generate a 3D Gaussian G_{i,j}. Each 3D Gaussian is defined in terms of the center μ, orientation R, scale s, opacity o, and color c. The center μ of the 3D Gaussian is computed according to equation (3):

$$μ = r a {y}_{o} + d \cdot {ray}_{dir} \qquad ( 3 )$$

where rayₒ is the ray origin, ray_{dir} is the ray direction pre-computed from camera parameters, and d is the ray distance. 3D Gaussian generator 630 then passes 3D Gaussians 534 to aggregated Gaussian trainer 540.

Auxiliary token decoder 650 receives output auxiliary tokens of output token vector 522 and generates decoded auxiliary tokens 536. Output auxiliary tokens of output token vector 522 include an output sky token and output affine tokens. Auxiliary token decoder 650 passes the output sky token of output token vector 522 and ray direction through a multilayer perceptron and outputs the sky color according to equation (4):

$${c}_{sky} = {MLP}_{sky} ( γ ( d ) ; sky\_token ) \qquad ( 4 )$$

where d is the ray direction, γ is a frequency based positional embedding function, and sky_token is the output sky token. Auxiliary token decoder 650 passes each output affine token through a linear layer to generate a scaling matrix and a bias vector. Decoded auxiliary tokens 536 includes the sky color, scaling matrix and bias vector. Auxiliary token decoder 650 then passes decoded auxiliary tokens 536 to aggregated Gaussian trainer 540.

Referring back to FIG. 5, aggregated Gaussian trainer 540 receives multi-timestep images 418, velocity vectors 532, 3D Gaussians 534, and decoded auxiliary tokens 536 from token decoder 530. First, aggregated Gaussian trainer 540 aggregates 3D Gaussians 534 into an amodal representation from all observed timesteps using velocity vectors 532. More specifically, the translation of a 3D Gaussian 534 at time t′ is given according to equation (5):

$${μ}_{t \to {t}^{′}} = \{ \begin{matrix}{μ}_{t} - ( {t}^{′} - t ) {v}_{t}^{-} , {t}^{′} < t \\ {μ}_{t} + ( {t}^{′} - t ) {v}_{t}^{+} , {t}^{′} > t\end{matrix} \qquad ( 5 )$$

where

$$v ≡ [ {v}_{t}^{+} , {v}_{t}^{-} ]$$

is the velocity vector representing the backward and forward velocities of a 3D Gaussian at timestep t, and μₜ is the center. Then, the Gaussians [symbol] at an arbitrary timestep t′ are defined according to equation (6):

$${𝒢}_{t}^{′} = {U}_{t} {G}_{t \to {t}^{′}} \qquad ( 6 )$$

where G_{t→t′} are the translated 3D Gaussians 534 with centers μ_{t→t}′. Each translated 3D Gaussian is then projected and rendered onto a 2D image using a splatting based technique. Decoded auxiliary tokens 536 are then applied to the rendered image according to equation (7):

$$\hat{I} = S ( {I}_{GS} + ( 1 - \hat{O} ) \cdot {c}_{sky} ) + b \qquad ( 7 )$$

where I_{GS} is the rendered image, Ô is the opacity map of the rendered image, c_{sky} is the sky color given according to equation (4), S a scaling matrix and b a bias vector, and Î is the final rendered image.

Aggregated Gaussian trainer 540 then trains the final rendered images to match the corresponding multi-timestep image. During training, aggregated Gaussian trainer 540 minimizes the loss function given according to equation (8):

$$ℒ = {ℒ}_{recon} + {λ}_{sky} \cdot {ℒ}_{sky} + {ℒ}_{reg} \cdot {ℒ}_{reg} \qquad ( 8 )$$

where [symbol] _{recon} is the reconstruction loss given according to equation (9):

$${ℒ}_{recon} = {‖ \hat{I} - I ‖}_{2} + {‖ \hat{D} - D / max ( D ) ‖}_{1} + {λ}_{lpips} \cdot LPIPS ( \hat{I} , I ) \qquad ( 9 )$$

[symbol]

_{sky} is the sky loss given according to equation (10):

$${ℒ}_{sky} = {‖ \hat{O} - ( 1 - M ) ‖}_{1} \qquad ( 10 )$$

[symbol]

_{reg} is velocity regularization loss given according to equation (11):

$${ℒ}_{reg} = {‖ v ‖}_{2}^{2} / 3 \qquad ( 11 )$$

and Î is the final rendered image, \hat{D} the depth map of the rendered image, Ô the opacity map of the rendered image, I is the corresponding multi-timestep image, D the corresponding depth map, M is the sky mask predicted by a pre-trained segmentation model (not shown), and LPIPS is the learned perceptual image patch similarity metric. Aggregated Gaussian trainer 540 can use any feasible training technique to train the final rendered images, such as stochastic gradient descent with backpropagation or adaptive moment estimation (Adam). After training, aggregated Gaussian trainer 540 generates optimized 3D Gaussians 542. The optimized 3D Gaussians 542 are used to generate dynamic reconstructed 3D scene 422 that closely matches multi-timestep images 418.

### Generating Dynamic Reconstructed 3D Scenes

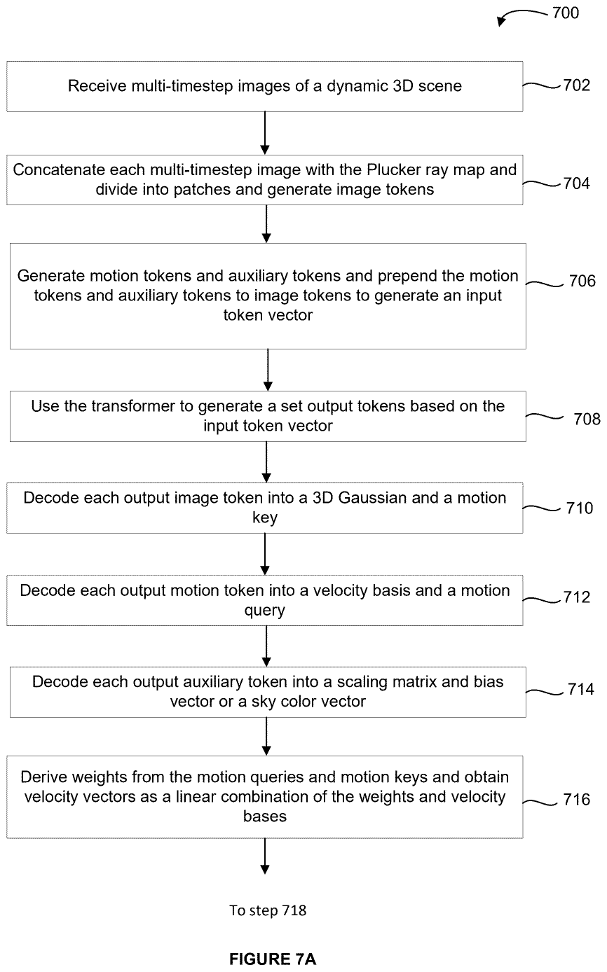

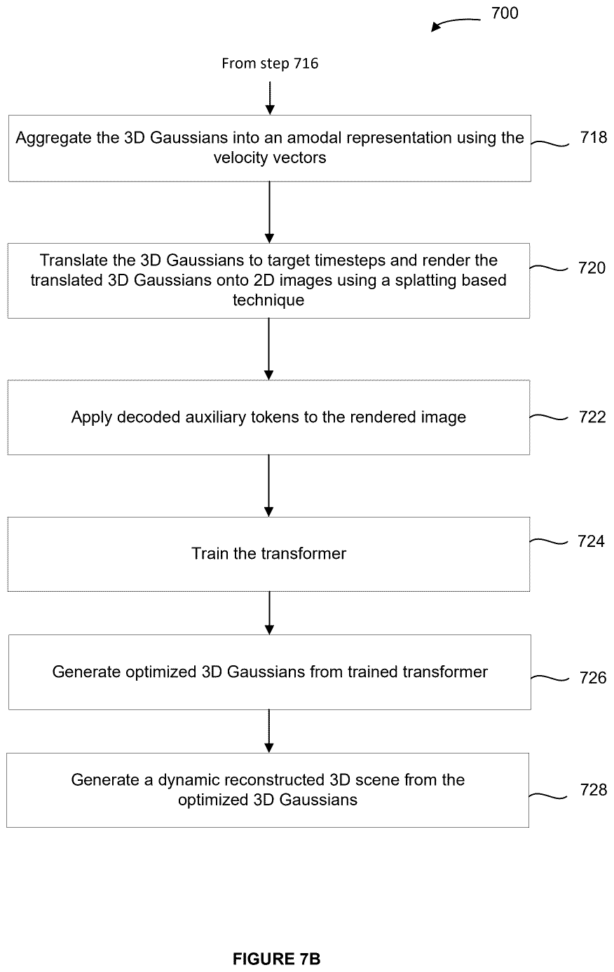

FIGS. 7A and 7B are a flow diagram of method steps for generating a dynamic reconstructed 3D scene, according to various embodiments. Although the method steps are described in conjunction with the embodiments of FIGS. 1-6, persons skilled in the art will understand that any system configured to perform the method steps, in any order, falls within the scope of the various embodiments.

As shown, a method 700 begins at step 702, where dynamic 3D scene reconstruction engine 416 receives multi-timestep images 418 of a dynamic 3D scene. Multi-timestep images 418 can be obtained by any type of technically feasible camera or video capture device such as camera(s) 435. For example, and without limitation, multi-timestep images 418 can be obtained by a monocular camera such as a smartphone camera or a camera located in a vehicle. In various embodiments, multi-timestep images 418 can include images of the same scene at different times in a given time interval from one or more viewpoints.

At step 704, token generator 510 concatenates each multi-timestep image 418 with a Plucker ray map and divides into patches and generates image tokens. More specifically, each multi-timestep image 418 is concatenated channel-wise with the Plucker ray map corresponding to multi-timestep image 418. The concatenated multi-timestep images 418 and Plucker ray map are then divided into non-overlapping 2D patches. Each 2D patch is flattened into a 1D vector and the 1D vector is then embedded through a linear patch embedding layer to obtain an image token for the 2D patch.

At step 706, token generator 510 generates motion tokens and auxiliary tokens and prepends the motion tokens and auxiliary tokens to the image tokens to generate an input token vector 512. Motion tokens and auxiliary tokens are learnable tokens initialized randomly. Motion tokens are used to capture common motion patterns in multi-timestep images 418. Auxiliary tokens include a sky token, to capture sky information from multi-timestep images 418, and an affine token, to capture exposure variations between camera(s) 435. Motion tokens and auxiliary tokens are prepended to the image tokens to generate input token vector 512.

At step 708, transformer 450 generates a set of output tokens based on the input token vector 512. Upon receiving input token vector 512, transformer 450 passes input token vector 512 through multiple transformer blocks. After passing input token vector 512 through the transformer blocks of transformer 450, transformer 450 generates output token vector 522. Output token vector 522 includes output image tokens, output motion tokens, and output auxiliary tokens.

At step 710, token decoder 530 decodes each output image token into a 3D Gaussian and a motion key. More specifically, 3D Gaussian generator 630 of token decoder 530 passes each output image token of output token vector 522 through a linear layer to generate a 3D Gaussian. Each 3D Gaussian is defined in terms of the center μ, orientation R, scale s, opacity o, and color c. The center of the 3D Gaussian is computed according to equation (3). Mask decoder 620 of token decoder 530 receives output image tokens of output token vector 522 and passes each output image token of output token vector 522 through several deconvolutional layers to generate a motion key.

At step 712, mask decoder 620 decodes each output motion token into a velocity basis and a motion query. More specifically, mask decoder 620 passes each motion token of output token vector 522 through a set of multilayer perceptron layers to generate a velocity vector and a motion query.

At step 714, auxiliary token decoder 650 decodes each output auxiliary token into a scaling matrix and a bias vector or a sky color vector. Output auxiliary tokens of output token vector 522 include an output sky token and output affine tokens. Auxiliary token decoder 650 passes the output sky token of output token vector 522 and ray direction through a multilayer perceptron and outputs the sky color according to equation (4). Auxiliary token decoder 650 passes each output affine token through a linear layer to generate a scaling matrix and a bias vector.

At step 716, mask decoder 620 derives weights from the motion queries and motion keys and obtains velocity vectors as a linear combination of the weights and velocity bases. First, mask decoder 620 derives weights for combining the velocity bases by computing the similarity between the motion queries and motion keys according to equation (1). The weights given by equation (1) and the velocity bases are then combined to generate velocity vectors 532 according to equation (2).

At step 718, aggregated Gaussian trainer 540 aggregates the 3D Gaussians into an amodal representation from all observed timesteps using the velocity vectors. More specifically, the translation of a 3D Gaussian 534 at time t′ is given according to equation (5). Then, the Gaussians at an arbitrary timestep t′ are defined according to equation (6).

At step 720, aggregated Gaussian trainer 540 translates the 3D Gaussian to target timesteps and renders each translated 3D Gaussian onto a 2D image using a splatting based technique. More specifically, aggregated Gaussian trainer 540 uses the amodal representation of the 3D Gaussians defined according to equation (6) to translate the 3D Gaussian to the target timesteps. Then, aggregated Gaussian trainer 540 renders the translated 3D Gaussian onto a 2D image using a splatting based technique.

At step 722, aggregated Gaussian trainer 540 applies decoded auxiliary tokens 536 to the rendered image. Decoded auxiliary tokens 536 are applied to the rendered image in accordance with equation (7), where the sky color is given according to equation (4).

At step 724, aggregated Gaussian trainer 540 trains the transformer. More specifically, aggregated Gaussian trainer 540 trains the rendered images to match the corresponding multi-timestep images 418. During training, aggregated Gaussian trainer 540 minimizes the loss function given according to equation (8). The loss function of equation (8) is a combination of the reconstruction loss given according to equation (9), the sky loss given according to equation (10), and velocity regularization loss given according to equation (11). Aggregated Gaussian trainer can use any feasible training technique to train the rendered images, such as stochastic gradient descent with backpropagation, Adam, and/or the like.

At step 726, aggregated Gaussian trainer 540 generates optimized 3D Gaussians 542 from the trained transformer. After training, aggregated Gaussian trainer 540 generates optimized 3D Gaussians 542. The optimized 3D Gaussians 542 are used to generate dynamic reconstructed 3D scene 422 that closely matches multi-timestep images 418.

At step 728, aggregated Gaussian trainer 540 generates a dynamic reconstructed 3D scene 422 from the optimized 3D Gaussians 542. From the optimized 3D Gaussians 542, aggregated Gaussian trainer 540 generates dynamic reconstructed 3D scene 422 that best matches multi-timestep images 418 for that scene.

### Using Dynamic Reconstructed 3D Scene

FIG. 8 is a flow diagram of method steps for using a dynamic reconstructed 3D scene, according to various embodiments. Although the method steps are described in conjunction with the embodiments of FIGS. 1-6, persons skilled in the art will understand that any system configured to perform the method steps, in any order, falls within the scope of the various embodiments.

As shown, a method 800 begins at step 802, where application 445 receives location and orientation information. The location and orientation information can include a position of a device on which application 445 is executing, an orientation of the device, and/or a direction of travel for the device. For example, when the device is located in a vehicle, the location and orientation information can indicate where the vehicle is located and an orientation direction of the vehicle or an anticipated further location and orientation of the vehicle. Application 445 can be, without limitation, any type of navigation system, map, route and direction assistant, visualization assistant, and/or like in an autonomous or manned vehicle, a hand-held device, and/or a stationary device.

At step 804, application 445 loads dynamic reconstructed 3D scene 422. Application 445 accesses and loads dynamic reconstructed 3D scene 422. Application 445 can load dynamic reconstructed 3D scene 422 from any storage device, such as data store 420. Dynamic reconstructed 3D scene 422 can include any dynamic reconstructed 3D scene 422, such as dynamic reconstructed 3D scene 422 generated using method 700. In some embodiments, application 445 can load any number of dynamic reconstructed 3D scenes 422.

At step 806, application 445 uses dynamic reconstructed 3D scene 422 to render an image based on the location and orientation information. For example, application 445 uses vehicle location and position information and dynamic reconstructed 3D scene 422 to render an image of the current location. In various embodiments, application 445 uses the location and orientation of the device in which application 445 is executing to determine a corresponding viewing perspective in dynamic reconstructed 3D scene 422. Application 445 then uses the corresponding viewing perspective to render a view of the dynamic reconstructed 3D scene captured by dynamic reconstructed 3D scene 422. The view can assist a user during navigation by showing images of the 3D environment. Additionally or alternatively, the images can be further annotated to identify landmarks and/or other points of interest.

In sum, a dynamic 3D reconstruction of a 3D scene is generated using a set of 2D images observed at multiple timesteps. First, each 2D image is concatenated with the Plucker ray map for that 2D image then divided into patches to generate image tokens. Next, motion tokens and auxiliary tokens are prepended to the image tokens and input into a transformer. The transformer outputs an output token vector, with output image tokens, output motion tokens, and output auxiliary tokens. Each output auxiliary token is decoded into a scaling matrix and a bias vector or a sky color vector. Each output image token is decoded into a 3D Gaussian and a motion key. Each output motion token is decoded into a velocity basis and a motion query. Motion queries and motion keys are used to derive weights for combining velocity bases into velocity vectors for all 3D Gaussians. Using the velocity vectors, the 3D Gaussians are aggregated into an amodal representation from all observed timesteps and translated into the target timesteps. The translated 3D Gaussians are projected and rendered onto 2D images using a splatting based technique. Then, the decoded auxiliary tokens are applied to the rendered 2D image. The transformer is trained using the rendered 2D images, depth maps of the rendered 2D images, opacity maps of the rendered 2D images, and velocity vectors for all 3D Gaussians, along with the corresponding observed 2D images, depth maps of the observed 2D images, and sky masks of the observed 2D images. In some embodiments, the training minimizes a combination of reconstruction loss, sky loss, and/or velocity regularization loss. After training, the vision transformer outputs optimized 3D Gaussians which are usable to reconstruct a dynamic 3D scene at various timesteps that closely match the originally observed 2D images.

At least one technical advantage of the disclosed techniques relative to the prior art is that, with the disclosed techniques, accurate dynamic reconstruction of 3D scenes can be generated from a sparse number of multi-timestep images. The disclosed techniques can generate accurate dynamic reconstruction of 3D scenes from a unified representation of multi-timestep images of that scene that is consistent over time, eliminating the need for per-scene optimization which requires a large number of images and large labeled datasets to generate the dynamic reconstructed 3D scene. In addition, with the disclosed techniques accurate dynamic reconstruction of 3D scenes can be generated without having to train specialized neural models, which significantly reduces the computing resources used to generate the dynamic reconstructed 3D scene. These technical advantages represent one or more technological improvements over prior art approaches.
1. In some embodiments, a computer-implemented method for reconstructing 3D scenes, the method comprising receiving a plurality of multi-timestep images of a scene, dividing each of the plurality of multi-timestep images into a plurality of patches, generating an image token for each patch of the plurality of patches to generate a plurality of image tokens, appending one or more motion tokens to the plurality of image tokens to generate an input token vector, processing the input token vector with a machine learning model to generate an output token vector, decoding each output image token in the output token vector to generate a 3D Gaussian and a motion key, decoding each output motion token in the output token vector to generate a velocity basis and a motion query, generating a plurality of velocity vectors based on the motion queries and the motion keys, generating an output 2D image for a first timestep based on the 3D Gaussians and the plurality of velocity vectors, training the machine learning model based on the output 2D image, generating optimized 3D Gaussians using the trained machine learning model, and generating a dynamic reconstructed 3D scene from the optimized 3D Gaussians.
2. The computer-implemented method of claim 1, wherein the plurality of multi-timestep images are captured using a plurality of cameras at a plurality of timesteps.
3. The computer-implemented method of claim 1, wherein the machine learning model comprises a vision transformer.
4. The computer-implemented method of claim 1, further comprising concatenating each of the plurality of multi-timestep images with a corresponding Plucker ray map.
5. The computer-implemented method of claim 1, further comprising further prepending one or more auxiliary tokens to the image tokens to generate the input token vector, wherein the one or more auxiliary tokens comprise one or more of a sky token or an affine token, the affine token capturing exposure variations between cameras used to capture the plurality of multi-timestep images.
6. The computer-implemented method of claim 1, wherein the motion key comprises a motion key vector corresponding to a spatial location in the scene.
7. The computer-implemented method of claim 1, wherein generating the plurality of velocity vectors based on the motion queries and the motion keys comprises deriving weights from the motion queries and the motion keys, and determining the velocity vectors as a linear combination of the weights and velocity bases.
8. The computer-implemented method of claim 1, wherein generating the output 2D image for the first timestep comprises translating the 3D Gaussians to the first timestep using the velocity vectors, and generating the output 2D image from the translated 3D Gaussians using splatting.
9. The computer-implemented method of claim 1, wherein training the machine learning model comprises computing a loss based on one or more of a reconstruction loss, a sky loss, or a velocity regularization loss.
10. The computer-implemented method of claim 1, further comprising aggregating the 3D Gaussians for a plurality of timesteps using the velocity vectors to generate an amodal representation.
11. In some embodiments, one or more non-transitory computer-readable media storing instructions that, when executed by at least one processor, cause the at least one processor to perform the steps of receiving a plurality of multi-timestep images of a scene, dividing each of the plurality of multi-timestep images into a plurality of patches, generating an image token for each patch of the plurality of patches to generate a plurality of image tokens, appending one or more motion tokens to the plurality of image tokens to generate an input token vector, processing the input token vector with a machine learning model to generate an output token vector, decoding each output image token in the output token vector to generate a 3D Gaussian and a motion key, decoding each output motion token in the output token vector to generate a velocity basis and a motion query, generating a plurality of velocity vectors based on the motion queries and the motion keys, generating an output 2D image for a first timestep based on the 3D Gaussians and the plurality of velocity vectors, training the machine learning model based on the output 2D image, generating optimized 3D Gaussians using the trained machine learning model, and generating a dynamic reconstructed 3D scene from the optimized 3D Gaussians.
12. The one or more non-transitory computer-readable media of claim 11, wherein the steps further comprise further prepending one or more auxiliary tokens to the image tokens to generate the input token vector.
13. The one or more non-transitory computer-readable media of claim 12, wherein the one or more auxiliary tokens comprise one or more of a sky token or an affine token, the affine token capturing exposure variations between cameras used to capture the plurality of multi-timestep images.
14. The one or more non-transitory computer-readable media of claim 12, further comprising generating a scaling matrix and a bias vector based on each affine token in the output token vector, and updating the output 2D image based on the scaling matrix and the bias vector.
15. The one or more non-transitory computer-readable media of claim 12, further comprising generating a sky color vector from a sky color token in the output token vector, and determining a color of sky in the output 2D image based on the sky color vector.
16. The one or more non-transitory computer-readable media of claim 11, wherein generating the plurality of velocity vectors based on the motion queries and the motion keys comprises deriving weights from the motion queries and the motion keys, and determining the velocity vectors as a linear combination of the weights and velocity bases.
17. The one or more non-transitory computer-readable media of claim 11, wherein generating the plurality of velocity vectors based on the motion queries and the motion keys comprises deriving weights from the motion queries and the motion keys, and determining the velocity vectors as a linear combination of the weights and velocity bases.
18. The one or more non-transitory computer-readable media of claim 11, wherein generating the output 2D image for the first timestep comprises translating the 3D Gaussians to the first timestep using the velocity vectors, and generating the output 2D image from the translated 3D Gaussians using splatting.
19. The computer-implemented method of claim 1, wherein training the machine learning model comprises computing a loss based on one or more of a reconstruction loss, a sky loss, or a velocity regularization loss.
20. In some embodiments, a system, comprising one or more memories storing instructions, and one or more processors that are coupled to the one or more memories and, when executing the instructions, are configured to perform steps comprising receiving a plurality of multi-timestep images of a scene, dividing each of the plurality of multi-timestep images into a plurality of patches, generating an image token for each patch of the plurality of patches to generate a plurality of image tokens, appending one or more motion tokens to the plurality of image tokens to generate an input token vector, processing the input token vector with a machine learning model to generate an output token vector, decoding each output image token in the output token vector to generate a 3D Gaussian and a motion key, decoding each output motion token in the output token vector to generate a velocity basis and a motion query, generating a plurality of velocity vectors based on the motion queries and the motion keys, generating an output 2D image for a first timestep based on the 3D Gaussians and the plurality of velocity vectors, training the machine learning model based on the output 2D image, generating optimized 3D Gaussians using the trained machine learning model, and generating a dynamic reconstructed 3D scene from the optimized 3D Gaussians.

Any and all combinations of any of the claim elements recited in any of the claims and/or any elements described in this application, in any fashion, fall within the contemplated scope of the present disclosure and protection.

The descriptions of the various embodiments have been presented for purposes of illustration, but are not intended to be exhaustive or limited to the embodiments disclosed. Many modifications and variations will be apparent to those of ordinary skill in the art without departing from the scope and spirit of the described embodiments.

Aspects of the present embodiments may be embodied as a system, method or computer program product. Accordingly, aspects of the present disclosure may take the form of an entirely hardware embodiment, an entirely software embodiment (including firmware, resident software, micro-code, etc.) or an embodiment combining software and hardware aspects that may all generally be referred to herein as a “module” or “system.” Furthermore, aspects of the present disclosure may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

Aspects of the present disclosure are described above with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine. The instructions, when executed via the processor of the computer or other programmable data processing apparatus, enable the implementation of the functions/acts specified in the flowchart and/or block diagram block or blocks. Such processors may be, without limitation, general purpose processors, special-purpose processors, application-specific processors, or field-programmable gate arrays.

The flowchart and block diagrams in the figures illustrate the architecture, functionality, and operation of possible implementations of systems, methods and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

While the preceding is directed to embodiments of the present disclosure, other and further embodiments of the disclosure may be devised without departing from the basic scope thereof, and the scope thereof is determined by the claims that follow.

What is claimed is:

1. A computer-implemented method for reconstructing 3D scenes, the method comprising:
receiving a plurality of multi-timestep images of a scene;
dividing each of the plurality of multi-timestep images into a plurality of patches;
generating an image token for each patch of the plurality of patches to generate a plurality of image tokens;
appending one or more motion tokens to the plurality of image tokens to generate an input token vector;
processing the input token vector with a machine learning model to generate an output token vector;
decoding each output image token in the output token vector to generate a 3D Gaussian and a motion key;
decoding each output motion token in the output token vector to generate a velocity basis and a motion query;
generating a plurality of velocity vectors based on the motion queries and the motion keys;
generating an output 2D image for a first timestep based on the 3D Gaussians and the plurality of velocity vectors;
training the machine learning model based on the output 2D image;
generating optimized 3D Gaussians using the trained machine learning model; and
generating a dynamic reconstructed 3D scene from the optimized 3D Gaussians.

2. The computer-implemented method of claim 1, wherein the plurality of multi-timestep images are captured using a plurality of cameras at a plurality of timesteps.

3. The computer-implemented method of claim 1, wherein the machine learning model comprises a vision transformer.

4. The computer-implemented method of claim 1, further comprising concatenating each of the plurality of multi-timestep images with a corresponding Plucker ray map.

5. The computer-implemented method of claim 1, further comprising further prepending one or more auxiliary tokens to the image tokens to generate the input token vector; wherein the one or more auxiliary tokens comprise one or more of a sky token or an affine token, the affine token capturing exposure variations between cameras used to capture the plurality of multi-timestep images.

6. The computer-implemented method of claim 1, wherein the motion key comprises a motion key vector corresponding to a spatial location in the scene.

7. The computer-implemented method of claim 1, wherein generating the plurality of velocity vectors based on the motion queries and the motion keys comprises:
deriving weights from the motion queries and the motion keys; and
determining the velocity vectors as a linear combination of the weights and velocity bases.

8. The computer-implemented method of claim 1, wherein generating the output 2D image for the first timestep comprises:
translating the 3D Gaussians to the first timestep using the velocity vectors; and
generating the output 2D image from the translated 3D Gaussians using splatting.

9. The computer-implemented method of claim 1, wherein training the machine learning model comprises computing a loss based on one or more of a reconstruction loss, a sky loss, or a velocity regularization loss.

10. The computer-implemented method of claim 1, further comprising aggregating the 3D Gaussians for a plurality of timesteps using the velocity vectors to generate an amodal representation.

11. One or more non-transitory computer-readable media storing instructions that, when executed by at least one processor, cause the at least one processor to perform the steps of:
receiving a plurality of multi-timestep images of a scene;
dividing each of the plurality of multi-timestep images into a plurality of patches;
generating an image token for each patch of the plurality of patches to generate a plurality of image tokens;
appending one or more motion tokens to the plurality of image tokens to generate an input token vector;
processing the input token vector with a machine learning model to generate an output token vector;
decoding each output image token in the output token vector to generate a 3D Gaussian and a motion key;
decoding each output motion token in the output token vector to generate a velocity basis and a motion query;
generating a plurality of velocity vectors based on the motion queries and the motion keys;
generating an output 2D image for a first timestep based on the 3D Gaussians and the plurality of velocity vectors;
training the machine learning model based on the output 2D image;
generating optimized 3D Gaussians using the trained machine learning model; and
generating a dynamic reconstructed 3D scene from the optimized 3D Gaussians.

12. The one or more non-transitory computer-readable media of claim 11, wherein the steps further comprise further prepending one or more auxiliary tokens to the image tokens to generate the input token vector.

13. The one or more non-transitory computer-readable media of claim 12, wherein the one or more auxiliary tokens comprise one or more of a sky token or an affine token, the affine token capturing exposure variations between cameras used to capture the plurality of multi-timestep images.

14. The one or more non-transitory computer-readable media of claim 12, further comprising:
generating a scaling matrix and a bias vector based on each affine token in the output token vector; and
updating the output 2D image based on the scaling matrix and the bias vector.

15. The one or more non-transitory computer-readable media of claim 12, further comprising:
generating a sky color vector from a sky color token in the output token vector; and
determining a color of sky in the output 2D image based on the sky color vector.

16. The one or more non-transitory computer-readable media of claim 11, wherein generating the plurality of velocity vectors based on the motion queries and the motion keys comprises:
deriving weights from the motion queries and the motion keys; and
determining the velocity vectors as a linear combination of the weights and velocity bases.

17. The one or more non-transitory computer-readable media of claim 11, wherein generating the plurality of velocity vectors based on the motion queries and the motion keys comprises:
deriving weights from the motion queries and the motion keys; and
determining the velocity vectors as a linear combination of the weights and velocity bases.

18. The one or more non-transitory computer-readable media of claim 11, wherein generating the output 2D image for the first timestep comprises:
translating the 3D Gaussians to the first timestep using the velocity vectors; and
generating the output 2D image from the translated 3D Gaussians using splatting.

19. The computer-implemented method of claim 1, wherein training the machine learning model comprises computing a loss based on one or more of a reconstruction loss, a sky loss, or a velocity regularization loss.

20. A system, comprising:
one or more memories storing instructions; and
one or more processors that are coupled to the one or more memories and, when executing the instructions, are configured to perform steps comprising:
receiving a plurality of multi-timestep images of a scene;
dividing each of the plurality of multi-timestep images into a plurality of patches;
generating an image token for each patch of the plurality of patches to generate a plurality of image tokens;
appending one or more motion tokens to the plurality of image tokens to generate an input token vector;
processing the input token vector with a machine learning model to generate an output token vector;
decoding each output image token in the output token vector to generate a 3D Gaussian and a motion key;
decoding each output motion token in the output token vector to generate a velocity basis and a motion query;
generating a plurality of velocity vectors based on the motion queries and the motion keys;
generating an output 2D image for a first timestep based on the 3D Gaussians and the plurality of velocity vectors;
training the machine learning model based on the output 2D image;
generating optimized 3D Gaussians using the trained machine learning model; and
generating a dynamic reconstructed 3D scene from the optimized 3D Gaussians.
